(19) United States
(12) Patent Application Publication
(10) Pub. No.: US 2023/0084856 A1
(43) Pub. Date: Mar. 16, 2023

(54) INTEGRATED VIEW OF LOCAL AND CLOUD FILES

(71) Applicant: Dell Products L.P., Round Rock, TX (US)

(72) Inventors: Shashiraja SHASTRY, Bangalore (IN); Charanya RAMRAJ, Chennai (IN); Shashank SHEKHAR, Mumbai (IN); Kanika BHATIA, Delhi (IN); Sharik Saigal M, Bangalore (IN)

(73) Assignee: Dell Products L.P., Round Rock, TX (US)

(21) Appl. No.: 17/473,161

(22) Filed: Sep. 13, 2021

(51) Int. Cl. G06F 16/25; G06F 16/638; G06F 16/248; G06K 7/14; G06K 19/06; G06F 21/62

(52) U.S. Cl. CPC G06F 16/252; G06F 16/638; G06F 16/248; G06K 7/1417; G06K 19/06037; G06F 21/6209

(57) ABSTRACT

An information handling system may include at least one processor; and a non-transitory, computer-reading medium having instructions thereon that are executable by the at least one processor for: receiving a request to provide a preview of a file; determining a file type of the file; determining that no application associated with the file type is installed locally on the information handling system; transmitting a request to a remote application associated with a different information handling system for preview data of contents of the file; and receiving the preview data from the remote application.

### TECHNICAL FIELD

The present disclosure relates in general to information handling systems, and more particularly to accessing and previewing files in information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Embodiments of this disclosure relate to a paradigm referred to herein as “hybrid client” or “modern client.” This paradigm typically involves the use of software that enables hybrid cloud management. This may include providing seamless access to applications and data whether they are stored locally at an information handling system, stored in the cloud, or stored in an organization's data center, and whether they are run via virtual machines (VMs) or on “bare metal” systems.

Some operating systems (OSes) such as Windows, Mac OS, etc. may provide preview functionality used in browsing files. For purposes of this disclosure, the term “preview” refers to a representation of file contents that is typically read-only and typically takes less storage space than the actual file, but generally provides enough information for a user to get an idea of the file contents.

Existing preview functionality is limited to showing content based on the locally installed applications. That is, if a particular file is associated with a cloud application, but not a locally installed application, the preview will not be available. Further, due to storage limitation in certain cases, it is not always feasible to locally install the associated application(s).

Even with virtual desktop infrastructure (VDI) or cloud applications configured, the previews cannot be generated using those applications. In existing implementations, the cloud files would need to be downloaded locally, and the file type (e.g., as indicated by filename extension or another suitable method) would need to be supported by a local application in order to see the preview.

Further, in existing solutions, there is no support for accessing a preview of cloud files when the network is unavailable. There is further no support for accessing a preview “on the go” via a mobile device. There is further no support for accessing a preview in a speech format as opposed to a visual format, which can impact accessibility for certain group of people.

Embodiments of this disclosure may thus provide flexible preview functionality in a hybrid client file explorer that allows for an aggregated view of local, cloud, and network drives. Embodiments may support various file types regardless of whether a locally installed application is available to generate such previews. Embodiments may provide previews via a mobile device as well as via an audio interface.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with accessing and previewing files in information handling systems may be reduced or eliminated.

In accordance with embodiments of the present disclosure, an information handling system may include at least one processor; and a non-transitory, computer-reading medium having instructions thereon that are executable by the at least one processor for: receiving a request to provide a preview of a file; determining a file type of the file; determining that no application associated with the file type is installed locally on the information handling system; transmitting a request to a remote application associated with a different information handling system for preview data of contents of the file; and receiving the preview data from the remote application.

In accordance with these and other embodiments of the present disclosure, a method may include an information handling system receiving a request to provide a preview of a file; the information handling system determining a file type of the file; the information handling system determining that no application associated with the file type is installed locally on the information handling system; the information handling system transmitting a request to a remote application associated with a different information handling system for preview data of contents of the file; and the information handling system receiving the preview data from the remote application.

In accordance with these and other embodiments of the present disclosure, an article of manufacture may include a non-transitory, computer-readable medium having computer-executable code thereon that is executable by a processor of an information handling system for: receiving a request to provide a preview of a file; determining a file type of the file; determining that no application associated with the file type is installed locally on the information handling system; transmitting a request to a remote application associated with a different information handling system for preview data of contents of the file; and receiving the preview data from the remote application.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example architecture, in accordance with embodiments of the present disclosure; and

FIGS. 3-6 illustrate example sequence diagrams, in accordance with embodiments of the present disclosure.

### DETAILED DESCRIPTION

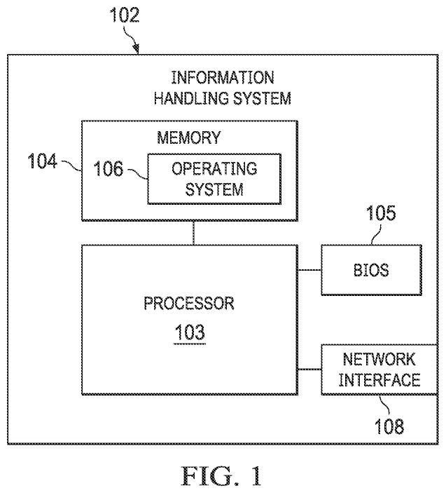

Preferred embodiments and their advantages are best understood by reference to FIGS. 1 through 6, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile and/or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

As discussed above, information handling system 102 may include functionality usable to preview files that are stored locally at memory 104, or accessible via network interface 108 (e.g., stored at an organization's data center or in the cloud).

In particular, if the selected file type is not supported by a local application, a preview of the file may nevertheless be generated as discussed herein. Once generated, the preview may be stored locally, allowing access to previews of remote files even when the network is unavailable. This allows a user to have some idea of the last-accessed file contents or a snapshot of the file for future reference.

According to one embodiment, at a high level, a preview of a local file may be generated as follows. First, if there is a locally installed application that is able to read the file and generate the preview, then the locally installed application may be used. If no such locally installed application is available, then a local preview generator application may convert the file to a common format such as PDF, and a preview of the PDF may be shown. Further, a cloud application or a VDI application may be used to generate the preview.

For cloud files, a similar process may ensure the availability of file preview even when the device has no network connection. To generate the preview of a cloud file, the file may be converted to a common format (e.g., PDF), which can then be cached locally and displayed in the preview pane using a common local application. If the selected file type is not supported by a local application but is supported using a cloud application, then the preview of the file may be obtained through the supported cloud application (e.g., in a browser window).

If the selected file type is not supported by a local application but is supported using a VDI application, then the preview of the file may be obtained by using the associated VDI application (e.g., within a preview container window).

Some embodiments of this disclosure may support mobile previews. According to one implementation, a Quick Response (QR) code may be generated, displayed on screen, and scanned (e.g., with a mobile device camera) to allow the preview of the selected file to be accessed on the mobile device. Securely sharing preview content can be enabled with additional passcode protection settings in some embodiments. In these and other embodiments, an auditory preview may also be generated by converting a preview with a text-to-speech module.

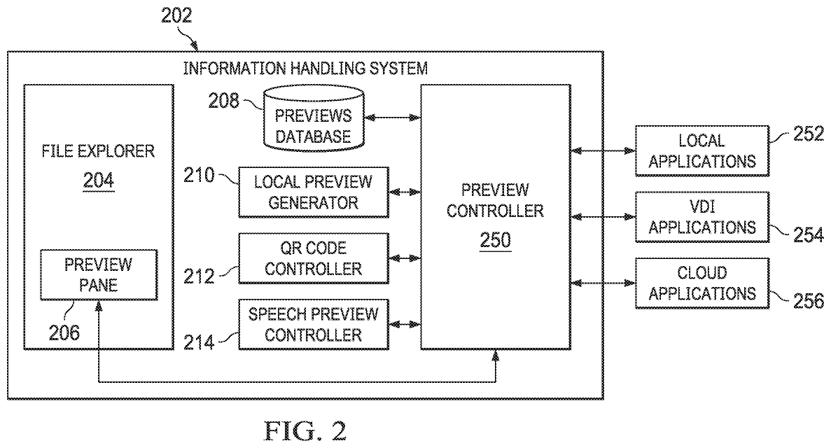

Turning now to FIG. 2, an example architecture is shown according to one embodiment. Information handling system 202 includes various modules (which may be implemented in software, hardware, firmware, or any combination thereof in particular embodiments).

In this embodiment, a preview pane 206 may be integrated into a window of file explorer 204. Data from local applications 252 and/or VDI applications 254 and/or cloud applications 256 may interact with a preview controller 250, as discussed in more detail below. Preview controller 250 acts as the main component of the preview system in this embodiment, and it may include or interface with various modules as shown. Local preview generator 210 may generate previews in a common file format, QR code controller 212 may generate QR code preview links, and speech preview controller 214 may generate speech previews. In some embodiments, a preview cache may be stored in previews database 208.

In one embodiment, a preview may be generated by local preview generator 210 as follows. First, a user may select a file for which a preview is to be displayed. When the selection event (e.g., a click event) is detected, the file type (e.g., as determined by file extension) and file path may be captured and sent to a background service. This data may act as an input to a conversion tool, which will convert the file to a common format. The conversion task may in some cases be handled by a standard conversion tool (e.g., unoconv or any other suitable tool). The output file may then be rendered in preview pane 206 as a read-only visual preview. In one embodiment, a preview may be generated by a VDI application 254 or a cloud application 256 as follows. The selected file may be launched using the associated cloud/VDI application in read-only mode. The application file stream may then be redirected to preview pane 206. This allows the user to view the file contents in a read-only preview.

In some embodiments, the generated preview may be cached (e.g., in previews database 208) to allow the user to access the preview of cloud files even when network connectivity is unavailable, providing previews without re-generating them as long as no changes have been made to the file, etc.

As noted above, some embodiments may enable the use of mobile previews, which may be accessed by a QR code or any other suitable identifying token. In one embodiment, a QR preview may be generated as follows. First, a user may select the file for which the preview is to be generated. After a preview is rendered in a preview pane or window in a read-only format, a user interface element such as a button may be displayed to generate a QR preview. If the user selects the QR preview, then the text (or other contents) of the selected file may be encoded and displayed (e.g., in an image format such as PNG) to the user using a tool like qrencode. The user may then scan the generated QR code to preview the selected file in any mobile device.

For enhanced security, one embodiment may allow for sending a file link and a secure code such as an access password to two different devices or via two different transmission channels. For example, if the file is to be shared via email, then the code may be sent via SMS to a phone number (or vice versa). The file link may be active for only a limited amount of time (e.g., 15 minutes), and it may expire if it is not opened within that time. The file may be sent in a password-protected mode, such that the user needs the password to open the linked file.

As noted above, some embodiments may enable the use of an auditory (e.g., speech) file preview. In one embodiment, a speech preview may be generated as follows. First, a user may select the file for which a speech preview is to be generated. After a preview is rendered in a preview pane or window in a read-only format, a user interface element such as a button may be displayed to generate a speech preview. If the user selects the speech preview, then an audio version of the selected file may be encoded (e.g., in WAV format). This version may be generated using standard text-to-speech tools such as espeak, festival, etc. In some embodiments, cloud APIs such as Microsoft® Azure Speech Services and Google® Cloud Text-to-Speech may also be supported. The user may then click a user interface element such as a play button in the preview pane to listen to the speech preview.

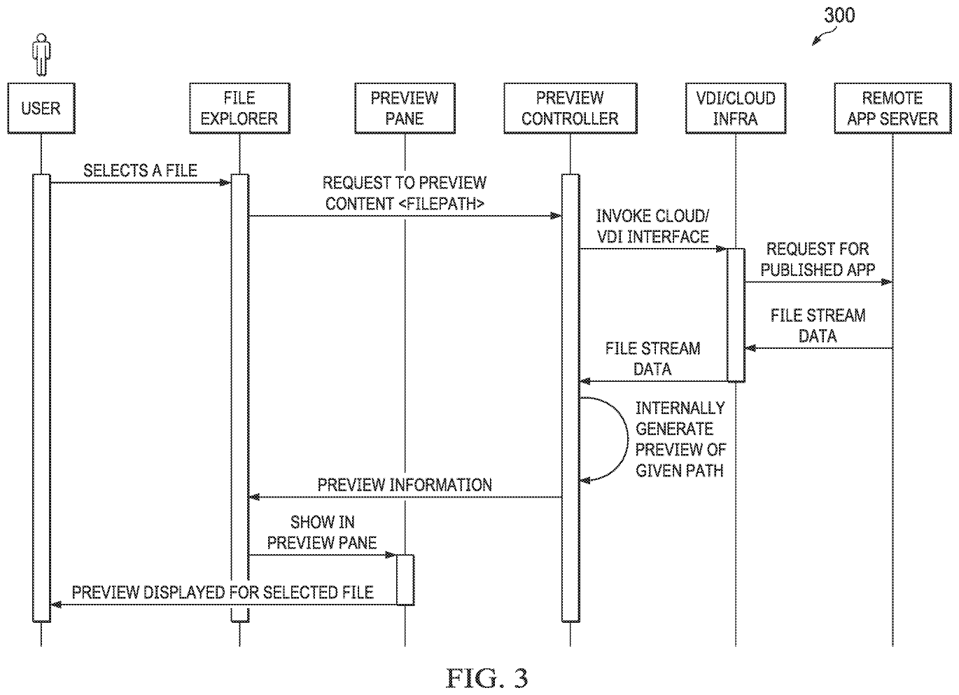

Turning now to FIG. 3, an example sequence diagram 300 is shown for file preview when a network connection is available, according to some embodiments.

As shown, a user may interact with a file explorer and select a file. The file explorer may communicate with a preview controller (which may be run locally on the same system in some embodiments), passing a request to preview the content.

The preview controller may invoke a cloud application and/or VDI application interface as appropriate, which may communicate with a remote application server as shown. Once the file stream data is received from the remote application server, it may be passed back to the preview controller.

The preview controller may internally generate a preview based on the file stream data, passing the preview information back to the file explorer. The file explorer may then display the preview to the user in a preview pane.

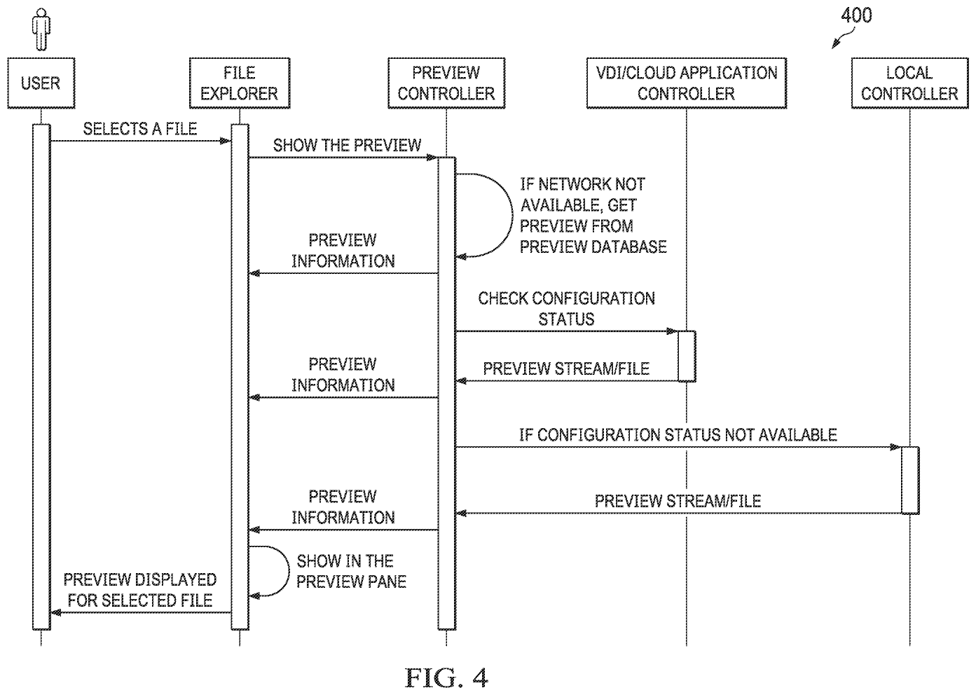

Turning now to FIG. 4, an example sequence diagram 400 is shown for file preview when a network connection is not available, according to some embodiments.

As shown, a user may interact with a file explorer and select a file. The file explorer may communicate with a preview controller to request that a file preview be shown. The preview controller, in response to the network being unavailable, may retrieve the preview data from a preview database and return the preview information to the file explorer.

The preview controller may also communicate with a VDI/cloud application controller as appropriate to check configuration status of VDI/cloud applications and preview the file stream. If configuration status is not available, then the preview controller may interact with a local controller to attempt to preview the file in that way.

In any event, the preview controller may pass the preview information back to the file explorer. The file explorer may then display the preview to the user in a preview pane.

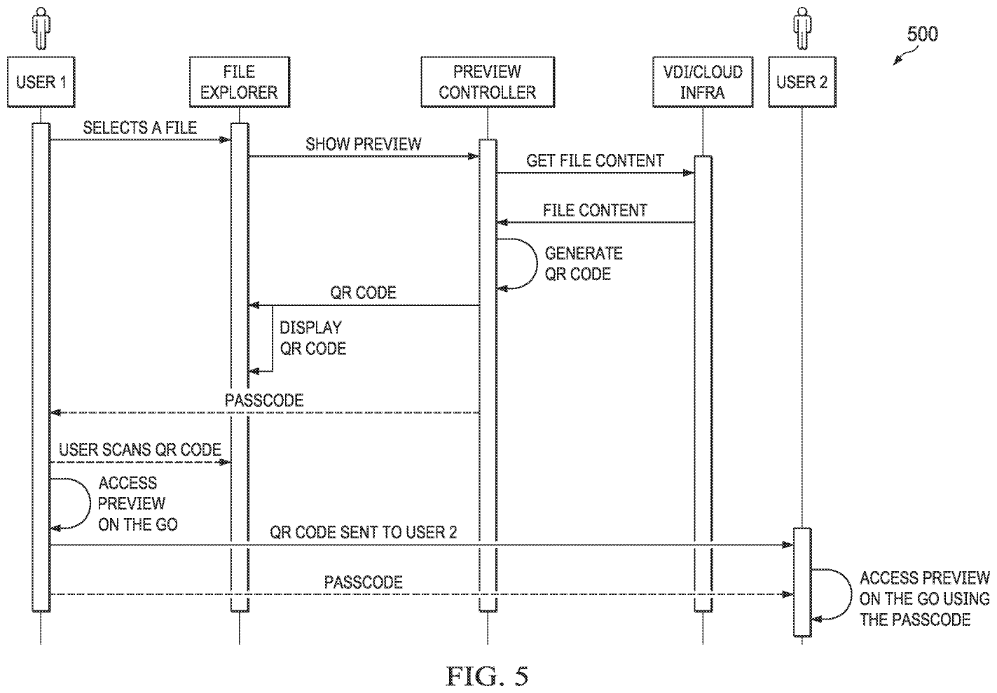

Turning now to FIG. 5, an example sequence diagram 500 is shown for file preview with access on the go with secure sharing, according to some embodiments.

As shown, a first user may interact with a file explorer and select a file. The file explorer may communicate with a preview controller to request that a file preview be shown. The preview controller may communicate with VDI and/or cloud infrastructure as appropriate to obtain the file contents.

The preview controller may then generate a QR code based on the file contents and pass it to the file explorer for display. The preview controller may also in some embodiments transmit a passcode to the first user to enable secure access to the file via the QR code.

The first user may also transmit the QR code and passcode to a second user (e.g., via separate transmission media for security). The second user may then also be able to use the QR code and passcode to access the preview.

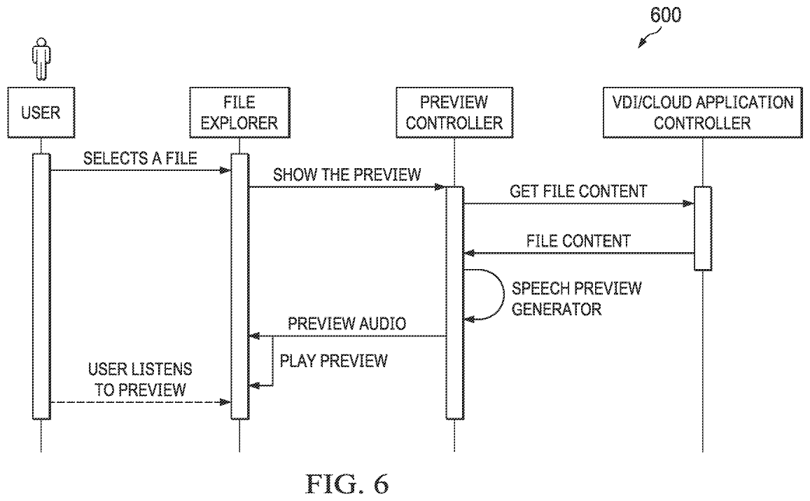

Turning now to FIG. 6, an example sequence diagram 600 is shown for file preview with speech preview, according to some embodiments.

As shown, a user may interact with a file explorer and select a file. The file explorer may communicate with a preview controller to request that a file preview be shown. The preview controller may communicate with a VDI and/or cloud application controller as appropriate to obtain the file contents.

The preview controller may then generate a speech-based preview based on the file contents and pass it to the file explorer for playback on an audio device.

One of ordinary skill in the art with the benefit of this disclosure will understand that the preferred initialization points for the methods depicted in FIGS. 3-6 and the order of the steps comprising those methods may depend on the implementation chosen. In these and other embodiments, the methods may be implemented as hardware, firmware, software, applications, functions, libraries, or other instructions. Further, although FIGS. 3-6 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

Accordingly, embodiments of this disclosure may provide many advantages. For example, a mechanism is disclosed to extract file contents even when the associated application is not installed in the local system, by either converting into a common format or using VDI/cloud remote applications. Further, a mechanism is disclosed to share the file preview to another user securely. This may also be extended to share the complete file on mobile platforms. The ability to generate and share the file's preview in an audio format to be played locally or on cloud platforms is also enabled. Further, a cached copy of local and cloud file previews may be utilized when the device is offline.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a non-transitory, computer-reading medium having instructions thereon that are executable by the at least one processor for:
receiving a request to provide a preview of a file;
determining a file type of the file;
determining that no application associated with the file type is installed locally on the information handling system;
transmitting a request to a remote application associated with a different information handling system for preview data of contents of the file; and
receiving the preview data from the remote application.

2. The information handling system of claim 1, wherein the preview is displayable in a preview portion of a user interface of a file explorer of the information handling system.

3. The information handling system of claim 1, wherein the preview is an audio-based preview that is configured for playback on an audio device of the information handling system.

4. The information handling system of claim 1, wherein the preview comprises a read-only version of at least a portion of contents of the file.

5. The information handling system of claim 1, wherein the file is stored on a networked information handling system remote to the information handling system.

6. The information handling system of claim 1, further configured to generate a Quick Response (QR) code based on the preview data.

7. The information handling system of claim 6, further configured to send the QR code to a recipient via a first transmission channel and send a passcode associated with the QR code to the recipient via a second transmission channel, wherein a combination of the QR code and the passcode is configured to provide access to the preview.

8. A method comprising:
an information handling system receiving a request to provide a preview of a file;
the information handling system determining a file type of the file;
the information handling system determining that no application associated with the file type is installed locally on the information handling system;
the information handling system transmitting a request to a remote application associated with a different information handling system for preview data of contents of the file; and
the information handling system receiving the preview data from the remote application.

9. The method of claim 8, wherein the preview is displayable in a preview portion of a user interface of a file explorer of the information handling system.

10. The method of claim 8, wherein the preview is an audio-based preview that is configured for playback on an audio device of the information handling system.

11. The method of claim 8, wherein the preview comprises a read-only version of at least a portion of contents of the file.

12. The method of claim 8, wherein the file is stored on a networked information handling system remote to the information handling system.

13. The method of claim 8, further comprising generating a Quick Response (QR) code based on the preview data.

14. The method of claim 8, further comprising sending the QR code to a recipient via a first transmission channel and sending a passcode associated with the QR code to the recipient via a second transmission channel, wherein a combination of the QR code and the passcode is configured to provide access to the preview.

15. An article of manufacture comprising a non-transitory, computer-readable medium having computer-executable code thereon that is executable by a processor of an information handling system for:
receiving a request to provide a preview of a file;
determining a file type of the file;
determining that no application associated with the file type is installed locally on the information handling system;
transmitting a request to a remote application associated with a different information handling system for preview data of contents of the file; and
receiving the preview data from the remote application.

16. The article of claim 15, wherein the preview is displayable in a preview portion of a user interface of a file explorer of the information handling system.

17. The article of claim 15, wherein the preview is an audio-based preview that is configured for playback on an audio device of the information handling system.

18. The article of claim 15, wherein the preview comprises a read-only version of at least a portion of contents of the file.

19. The article of claim 15, wherein the file is stored on a networked information handling system remote to the information handling system.

20. The article of claim 15, wherein the code is further executable for generating a Quick Response (QR) code based on the preview data.
